(19) United States
(12) Patent Application Publication
(10) Pub. No.: US 2026/0307117 A1
(43) Pub. Date: Oct. 8, 2026

(54) PROCESS FOR CLEANING OR REMOVING SOLIDS FROM TANKS

(71) Applicant: Wacker Chemie AG, Munich (DE)

(72) Inventors: Saptarshi Chakraborty, Cleveland, TN (US); Amanda Marques, Cleveland, TN (US); William Sanderson, Cleveland, TN (US); Brandon Hendrick, Cleveland, TN (US)

(73) Assignee: Wacker Chemie AG, Munich (DE)

(21) Appl. No.: 19/637,891

(22) Filed: Apr. 2, 2026

Related U.S. Application Data
(60) Provisional application No. 63/782,703, filed on Apr. 3, 2025.

(51) Int. Cl. B08B 9/08; B01D 36/04; C11D 7/50

(52) U.S. Cl. CPC B08B 9/08; B01D 36/04; C11D 7/50; B08B 2209/08

(57) ABSTRACT

A process and system for cleaning, removing, dislodging, collecting and/or disposing of one or more solids from one or more tanks. The system includes one or more media tanks that are in fluid communication with one or more first tanks having one or more solids therein. Where a media from the one or more media tanks is brought into contact with the one or more solids to form a slurry that is transferred to one or more second tanks. The slurry within the one or more second tanks form a settled slurry having at least a portion of the one or more solids therein. At least a portion of silicon tetrachloride making up at least a portion of the media is removed from the one or more second tanks and the one or more solids are collected from the settled slurry formed.

### CROSS-REFERENCE TO RELATED APPLICATIONS

This application claims priority to U.S. Provisional Patent Application No. 63/782,703 filed on Apr. 3, 2025 which is incorporated by reference herein in its entirety.

### FIELD OF THE DISCLOSURE

The present disclosure is related to a methods or processes for cleaning (or sanitizing) or otherwise removing an amount of solids from within storage and/or feed tanks (or vessels). In particular, the present disclosure relates to methods or processes for cleaning or removing an amount of solids from within chlorosilane tanks or other storage and/or feed vessels that are used in the production of polysilicon materials.

### BACKGROUND OF THE DISCLOSURE

Various storage and/or feed tanks (or vessels) that are used in the production of polysilicon materials or processing of chlorosilanes typically have an amount of solids therein that tend to settle out over time or accumulate over time. As the solids settle out or accumulate within the tanks (or vessels), an amount of the solids tend to build up on at least a portion of an inner surface of the tanks (or vessels) and must be removed periodically. This is done for safety reasons and to ensure consistent and reliable production of products. Additionally, by removing the solids from the tanks (or vessels) periodically, it aids in reducing the overall amount of down time and volume loss associated with failures, equipment and/or instrumentation damage and/or quality issues which are attributable to the build-up of solids within the tanks (or vessels).

Various conventional methods are known for the cleaning of tanks (or vessels) and/or the removal of the solids from within the tanks (or vessels). Such methods include the use of hydrolysis to hydrolyze (or neutralize) the solids and then flush them out of the tanks (or vessels). However, the hydrolysis reaction is extremely exothermic and generates an amount of hydrochloric acid (or HCl), HCl gas and/or HCl liquid. Depending on the relative amount of water and solids present, the HCl may be in gaseous or aqueous form. The hydrolysis reaction is extremely volatile and unpredictable and is even more dangerous given the fact that in most instances the composition of the solids within the tanks (or vessels) is not fully known. Given the corrosive nature of HCl and its volatility, such processes are not desired due to health, safety and environmental reasons. Additionally, given the potential risk of an exothermic reaction and corrosive nature of the reaction, there is a risk that any such reaction may damage or negatively affect the integrity of the tanks (or vessels) and/or nearby personnel. Furthermore, given the fact that once the hydrolysis reaction begins there is no way to halt, stop or counteract the reaction, it poses additional undesirable risks to both the equipment and personnel. As a result, such processes are not desirable and a safer process is therefore needed.

Additionally, conventional methods of cleaning tanks (or vessels) and/or removing the solids therefrom require the addition of various filtering stages (or steps) that are built into the production process of polysilicon materials. These additional filtering steps aid in contributing to the time, expense and complexity associated with the production of polysilicon materials which is not desirable.

Furthermore, conventional methods of cleaning tanks (or vessels) and/or removing the solids therefrom requires the use of various solvents in an attempt to dissolve or break up the solids. This is not desirable as the solvents used are not able to be completely removed and therefore introduce impurities into the final product which is not desirable.

It would therefore be advantageous to develop a system and process (or method) for cleaning tanks (or vessels) and/or removing an amount of solids therefrom without the use of water, HCL, hydrolysis and/or other solvents. Additionally, it would be advantageous to develop a system and process (or method) for cleaning tanks (or vessels) and/or removing an amount of solids therefrom in a manner that is safer, more environmentally friendly and does not damage the tanks (or vessels) or any other equipment connected to or near the tanks (or vessels) having the undesirable solids therein. Furthermore, it would be advantageous to develop a system and process (or method) for cleaning tanks (or vessels) and/or removing an amount of solids therefrom which is quicker, less complex and more efficient thereby reducing down times and the overall costs and time associated with the manufacturing of polysilicon materials. Still further, it would be advantageous to develop a system and process (or method) for cleaning tanks (or vessels) and/or removing an amount of solids therefrom that does not require the addition of steps to the production process for various polysilicon materials and aids in improving the overall quality and/or purity of various polysilicon materials. At least a portion of the STC is removed from the one or more second tanks and collected for reuse. The STC collected may be collected within one or more third tanks. At least a portion of the one or more solids are collected from a settled slurry formed.

### SUMMARY OF THE DISCLOSURE

A process and system for cleaning, removing, dislodging, collecting and/or disposing of one or more solids from one or more tanks. Where the system includes one or more media tanks with an amount of a media therein that are in fluid communication with at least a portion of one or more first tanks. Where the media includes an amount of silicon tetrachloride (STC) therein and at least a portion of the media is brought into contact with at least a portion of one or more solids within the one or more first tanks to form a slurry. Where the slurry is delivered from the one or more first tanks to one or more second tanks where a settled slurry is formed that includes an amount of the one or more solids therein.

According to an embodiment of the disclosure and as a non-limiting example, the one or more solids may include an amount of one or more metal chlorides, aluminum chloride (AlCl3), silicon (grounds and/or fines), chlorosilanes, and/or high boiling chlorosilanes.

According to an embodiment of the disclosure and as a non-limiting example, the one or more first tanks may include one or more nozzles that are operably configured to deliver at least a portion of the media into the one or more first tanks and/or the one or more first tanks may include one or more nozzles that are operably configured to bring at least a portion of the media into contact with at least a portion of the one or more solids within the one or more first tanks.

According to an embodiment of the disclosure and as a non-limiting example, the one or more second tanks may include one or more additional nozzles that are operably configured to bring at least a portion of the media into contact with at least a portion of the one or more solids, the slurry and/or the settled slurry within the one or more second tanks.

According to an embodiment of the disclosure and as a non-limiting example, the system may further include the use of one or more first pumps that are operably configured to aid in delivering an amount of the media from within the one or more media tanks to the one or more first tanks and/or the one or more second tanks.

According to an embodiment of the disclosure and as a non-limiting example, the system may further include one or more third valves that are operably configured to selectively deliver an amount of the media to the one or more second tanks.

According to an embodiment of the disclosure and as a non-limiting example, at least a portion of the media may be recycled and/or upcycled from the production of polysilicon materials.

According to an embodiment of the disclosure and as a non-limiting example, the STC within the media may be used to dissolve or extract at least a portion of chlorosilanes and/or high boiling chlorosilane residues found within the one or more solids and/or the STC within the media may be used to form a suspension with at least a portion of one or more metal chlorides, aluminum chloride (AlCl3) and/or silicon found within the one or more solids in order to aid in the removal of the one or more solids form the system.

According to an embodiment of the disclosure and as a non-limiting example, the one or more solids within the system are not exposed to an amount of air, moisture and/or water.

According to an embodiment of the disclosure and as a non-limiting example, the one or more first tanks may include one or more nozzles that are integrally formed as part of the one or more first tanks and/or connected to an assembly that is operably configured to move the one or more nozzles in such a manner that the media is brought into contact with the one or more solids on an inner surface of the one or more first tanks.

According to an embodiment of the disclosure and as a non-limiting example, the system may include the use of one or more first filters. Where the one or more first filters are operably configured allow for the delivery of the STC from the one or more second tanks to the one or more third tanks while preventing or inhibiting unwanted portions of the slurry, a settled slurry and/or the one or more solids from entering into the one or more third tanks.

According to an embodiment of the disclosure and as a non-limiting example, m may include the use of one or more second filters that are operably configured to separate the one or more solids and the STC from the settled slurry and allow for the transfer of the one or more solids to one or more collection containers.

According to an embodiment of the disclosure and as a non-limiting example, the system may further include the use of polydimethylsiloxane that encapsulates at least a portion of the one or more solids thereby aiding in preventing the one or more solids from being reactive to air, water and/or moisture.

According to an embodiment of the disclosure and as a non-limiting example, the polydimethylsiloxane may be present in an amount of approximately 50:50 to approximately 30:70 based on the weight of the one or more solids to the polydimethylsiloxane.

The present disclosure also relates to a process for cleaning one or more tanks. Where the process includes the step of providing a media, wherein the media comprises silicon tetrachloride (STC) and contacting at least a portion of the media within at least a portion of one or more solids within one or more first tanks. Where a slurry is allowed to form within the one or more first tanks and includes the media and the one or more solids. The slurry formed is then delivered to one or more second tanks and an amount of the STC is removed and collected from the one or more second tanks. Within the one or more second tanks, a settled slurry which includes an amount of the one or more solids therein is allowed to form. An amount of the one or more solids is then collected from the settled slurry formed and at least a portion of the STC collected is re-used.

According to an embodiment of the disclosure and as a non-limiting example, the process may include the step of providing an amount of polydimethylsiloxane and allowing the polydimethylsiloxane to encapsulate at least a portion of the one or more solids so as to render the one or more solids non-reactive to air, water and/or moisture.

According to an embodiment of the disclosure and as a non-limiting example, the polydimethylsiloxane utilized within the process may be present in an amount of approximately 50:50 to approximately 30:70 based on the weight of the one or more solids to the polydimethylsiloxane.

According to an embodiment of the disclosure and as a non-limiting example, the process may include the step of delivering the one or more solids collected to one or more collection containers.

According to an embodiment of the disclosure and as a non-limiting example, the process may include the step of dissolving or extracting at least a portion of chlorosilanes and/or high boiling chlorosilane residues found within the one or more solids with the STC.

According to an embodiment of the disclosure and as a non-limiting example, the process may include the step of allowing a suspension to form. Where the suspension includes an amount of the STC from within the media and one or more metal chlorides, aluminum chloride (AlCl3) and/or silicon found within the one or more solids for collection and/or removal of the one or more solids.

According to an embodiment of the disclosure and as a non-limiting example, wherein the process may include the step of filtering and separating an amount of the STC and the one or more solids from the settled slurry formed within the one or more second tanks with one or more second filters. The STC separated by the one or more second filters may then be transferred to one or more third tanks and/or for re-use. The one or more solids separated by the one or more second filters may be transferred to one or more collection containers.

According to an embodiment of the disclosure and as a non-limiting example, the process may include the step of delivering an amount of the media to the one or more second tanks and contacting at least a portion of the media with at least a portion of the one or more solids, the slurry and/or the settled slurry within the one or more second tanks.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 is a schematic illustrating a process and system for cleaning and/or removing an amount of one or more solids from one or more tanks according to an embodiment of the disclosure; and

FIG. 2 is a flow chart illustrating the process for cleaning and/or removing an amount of one or more solids from one or more tanks according to an embodiment of the disclosure.

### DETAILED DESCRIPTION

It is to be understood that the invention may assume various alternative orientations, formulations, compositions and/or step sequences, except where expressly specified to the contrary. It is also understood that the specific devices, compositions, formulations and/or processes illustrated within the attached drawings and described within the specification are simply exemplary embodiments of the inventive concepts disclosed and defined herein. Hence, specific dimensions, formulations, compositions, directions and/or other physical characteristics relating to the various embodiments disclosed are not to be considered as limiting, unless expressly stated otherwise.

During the production of polysilicon materials and/or the processing of chlorosilanes that are produced during the production of polysilicon materials, an amount of one or more solids 102 tend to build up and/or aggregate within one or more first tanks 104 included within the production process. The present disclosure relates to a process 100 for cleaning and/or removing an amount of the one or more solids 102 from an inner surface 106 and/or an interior 108 of the one or more first tanks 104. It is within the scope of this disclosure and as a non-limiting example that the one or more solids 102 may include one or more metal chlorides, aluminum chloride (AlCl3), silicon (grounds and/or fines), chlorosilanes, and/or high boiling chlorosilanes.

The process 100 includes the use of one or more nozzles 110. The one or more nozzles 110 may be operably configured to deliver an amount of a media 112 into the interior 108 of the one or more first tanks 104 and/or onto at least a portion of the inner surface 106 of the one or more first tanks 104. It is within the scope of this disclosure and as a non-limiting example that the one or more nozzles 110 may be connected to or integrally formed as part of the one or more first tanks 104 utilized within the process 100. Additionally, it is within the scope of this disclosure and as a nonlimiting example that the one or more nozzles 110 may be operably configured to deliver an amount of the media 112 in substantially one direction and/or in multiple directions. Furthermore, it is within the scope of this disclosure and as a non-limiting example that the one or more nozzles 110 may be one or more high pressure nozzles that aid in breaking down and/or dislodging at least a portion of the one or more solids 102 from at least a portion of the inner surface 106 of the one or more first tanks 104. As an alternative and as a non-limiting example, the one or more nozzles 110 may be one or more low pressure nozzles. Still further, it is within the scope of this disclosure and as a non-limiting example that the one or more nozzles 110 may be operably configured to adjust the pressure, force and/or velocity of the media 112 exiting the one or more nozzles 110 as needed so as to aid in breaking down and/or dislodging at least a portion of the one or more solids 102 from at least a portion of the inner surface 106 of the one or more first tanks 104. This aids in allowing for the process 100 and the one or more nozzles 110 utilized therein to be customized as needed to ensure that the one or more solids 102 are broken down and/or dislodged from the inner surface 106 of the one or more first tanks 104. It is within the scope of this disclosure and as a non-limiting example that the one or more nozzles 110 may include one type of nozzle or a combination of different types of nozzles as may be need to aid in breaking down and/or dislodging at least a portion of the one or more solids 102 from at least a portion of the inner surface 106 of the one or more first tanks 104.

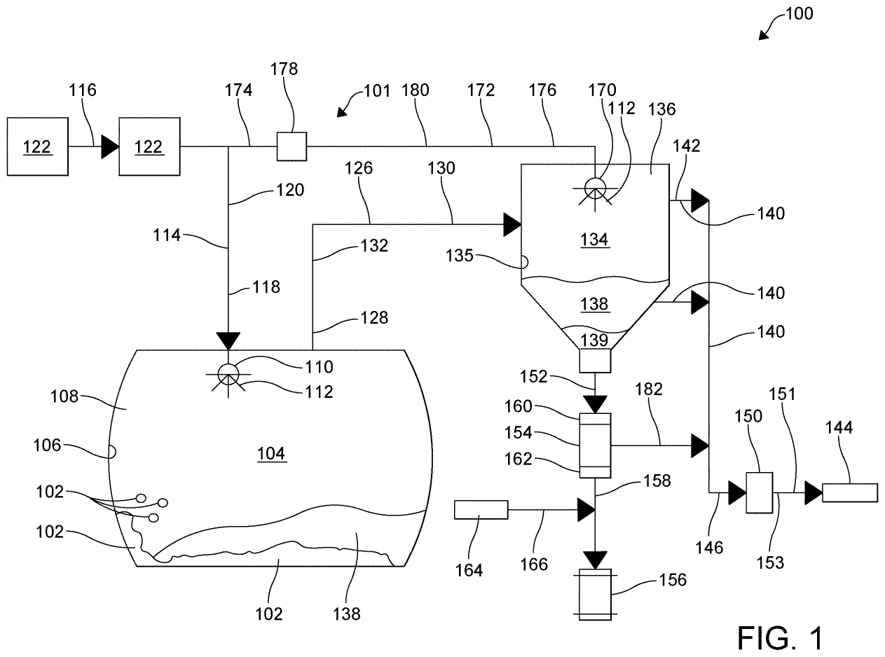

As illustrated in FIG. 1 of the disclosure and as a non-limiting example, the one or more nozzles 110 may be in communication or fluid communication with one or more first pipes 114. The one or more first pipes 114 may be operably configured to deliver or transmit an amount of the media 112 from one or more media tanks 122 to the one or more nozzles 110. It is therefore to be understood that the one or more media tanks 122 may be operably configured to retain an amount of the media 112 therein. Additionally, it is within the scope of this disclosure and as a non-limiting example that the one or more media tanks 122 may be operably configured to deliver or transmit or aid in the deliver or transmission of an amount of the media 112 from the one or more media tanks 122, through the one or more first pipes 114 and to the one or more nozzles 110.

As illustrated within FIG. 1 of the disclosure and as a non-limiting example, the one or more first pipes 114 have a first end portion 116, a second end portion 118 and an intermediate portion 120 interposed between the first end portion 116 and the second end portion 118 of the one or more first pipes 114. According to an embodiment of the disclosure and as a non-limiting example, at least a portion of the one or more media tanks 122 may be connected to and/or fluid communication with at least a portion of the first end portion 116 of the one or more first pipes 114 and at least a portion of the one or more nozzles 110 may be connected to and/or in fluid communication with at least a portion of the second end portion 118 of the one or more first pipes 114.

In accordance with an embodiment of the disclosure and as a non-limiting example, the process may include the use of one or more first pumps 124. The one or more first pumps 124 may be operably configured to deliver or aid in the delivery or transmission of an amount of the media 112 through the one or more first pipes 114 and to the one or more nozzles 110. It is within the scope of this disclosure and as a non-limiting example that the one or more first pumps 124 may be connected to and/or in fluid communication with at least a portion of the intermediate portion 120 of the one or more first pipes 114.

According to an embodiment of the disclosure and as a non-limiting example, the media 112 may include silicon tetrachloride (or STC). The STC utilized within the media 112 is something that is readily available in polysilicon production facilities as it is produced as a byproduct during the production of polysilicon materials. As the STC is continuously being produced during the production of polysilicon materials, there is always a quick and cost-efficient supply of the STC that is readily available for use within the media 112 as opposed to other materials or combinations of materials that may be used within the media 112. This new use or re-use for the STC produced allows for a recycling or upcycling of the STC thereby making the production of polysilicon materials more environmentally friendly, cost effective and sustainable. As the need for and therefore the production of polysilicon materials increases, it is desirable to ensure that the polysilicon production process is as environmentally friendly, cost effective and sustainable as possible versus conventional processes such as hydrolysis.

Additionally, there are a number of other benefits to using STC within the media 112. One other such benefit for the use of STC within the media 112 is the fact that the STC is compatible with the one or more solids 102. With regards to the chlorosilanes and/or the high boiling chlorosilane residues within the one or more solids 102, the STC portion of the media 112 is uniquely compatible of safely and effectively dissolving or extracting all or a portion of the chlorosilanes and/or the high boiling chlorosilane residues within the one or more solids 102. With regards to the one or more metal chlorides, aluminum chloride (AlCl3) and/or silicon (grounds and/or fines) within the one or more solids 102, the STC of the media 112 is uniquely capable of aiding in the formation of a suspension with the one or more metal chlorides, aluminum chloride (AlCl3) and/or silicon (grounds and/or fines) within the media 112. Once the suspension has been formed, it aids in the transmission or removal of at least a portion of the one or more solids 102 from the system 101. This unique compatibility of between the STC portion of the media 112 and the one or more solids 102 surprisingly and unexpectedly aids in the cleaning and/or removing at least a portion of the one or more solids 102 from the one or more first tanks 104 by breaking up and/or dislodging an amount of the one or more solids 102 from at least a portion of the inner surface 106 of the one or more first tanks 104 and transfer or convey it out of the system 101.

Furthermore, the use of STC within the media 112 is beneficial as it is effective in dislodging, removing and/or breaking down an amount of the one or more solids 102 from the system 101 without adding any additional impurities or contaminants into the system 101 and/or the production of polysilicon materials which may be hard, difficult and/or impossible to remove. This aids in increasing or maintaining the overall purity and quality of the polysilicon (not shown) produced and reduces the overall time and costs of manufacturing the same as the need to additional steps, processes and/or equipment is not needed to remove or reduce the amount of impurities within the polysilicon (not shown) produced when compared to conventional methods or systems. As a result, the STC within the media 112 does not have a negative impact on the overall purity and quality of the polysilicon (not shown) produced when compared to conventions methods or systems.

Still further, as the STC within the media 112 does not expose the one or more solids 102 to air and/or water which reduces the hazards associated with hydrolysis which are typically present when removing the one or more solids 102. Such hazards include, but are not limited to, explosions, fires, exposure to corrosive or toxic chemicals and/or acid or acidic gas leaks which can be hazardous to personnel and equipment and can even be deadly to personnel. As a result, this aids in improving the overall safety associated with the production of polysilicon materials and the removal of an amount of the one or more solids 102 and aids in improving the overall life of the equipment within the system 101 and/or the polysilicon production process (not shown).

According to an embodiment of the disclosure and as a non-limiting example that the one or more nozzles 110 may be operably configured to deliver an amount of the media 112 to the one or more solids 102 within the one or more first tanks 104 in a localized area. This aids in ensuring that the media 112 is delivered as a sufficient pressure or velocity as may be needed to dislodge at least a portion of the one or more solids 102 from the inner surface 106 of the one or more first tanks 104. Additionally, this aids in breaking up the one or more solids 102 into smaller pieces or aggregates. This aids in allowing at least a portion of the one or more solids 102 to quickly and efficiently dissolve within or extracted from a slurry 138 that is created (or formed) within the one or more first tanks 104 after the media 112 has been sprayed within the one or more first tanks 104.

In accordance with an embodiment of the disclosure and as a non-limiting example, the one or more nozzles 110 may be operably configured to rotate or otherwise move in a manner so as to ensure that the media 112 coming from the one or more nozzles 110 comes into direct contact with the one or more solids 102 on the inner surface 106 of the one or more first tanks 104. This aids in ensuring that all or substantially all of the one or more solids 102 are removed or dislodged from the inner surface 106 of the one or more first tanks 104 of the system 101. It is within the scope of this disclosure and as a non-limiting example that it may take one or more uses of the process 100 and the system 101 to ensure that all or substantially all of the one or more solids 102 are removed or dislodged from the inner surface 106 of the one or more first tanks 104.

According to an alternative embodiment of the disclosure and as a non-limiting example, the one or more nozzles 110 may be connected to an assembly (not shown) that is operably configured to move the one or more nozzles 110 in such a manner that the media 112 comes into direct contact with the one or more solids 102 on the inner surface 106 of the one or more first tanks 104. This aids in ensuring that all or substantially all of the one or more solids 102 are removed or dislodged from the inner surface 106 of the one or more first tanks 104 of the system 101. This also allows for the one or more nozzles 110 to be moved and/or directed in one or more positions as may be needed to ensure that all or substantially all of the one or more solids 102 are removed or dislodged from the inner surface 106 of the one or more first tanks 104.

Once the media 112 is dispensed or delivered into the interior 108 of the one or more first tanks 104, the media 112 and the one or more solids 102 form the slurry 138. Given the compatibility of the one or more solids 102 with the STC within the media 112, the one or more solids are allowed to dissolve within or extracted from the slurry 138 and/or form a suspension with the media 112 within the slurry 138.

As illustrated within FIG. 1 of the disclosure and as a non-limiting example, the system 101 may include one or more second pipes 126 having a first end portion 128, a second end portion 130 and an intermediate portion 132 interposed between the first end portion 128 and the second end portion 130. At least a portion of the first end portion 128 of the one or more second pipes 126 may be in fluid communication with at least a portion of the one or more first tanks 104 and at least a portion of the second end portion 130 of the one or more second pipes 126 may be in fluid communication with at least a portion of one or more second tanks 134. The slurry 138 is then transferred or delivered from within the one or more first tanks 104 and into an interior 136 of the one or more second tanks 134. It is within the scope of this disclosure and as a non-limiting example that the one or more second tanks 134 may be one or more settling tanks, one or more sedimentation tanks and/or any other type of tank that is operably configured to take advantage of the differences in density between the various components of the slurry 138.

As a non-limiting example, the system 101 may include the use of one or more second pumps (not shown) that are in fluid communication with at least a portion of the one or more second pipes 126. The one or more second pumps (not shown) may aid in allowing the transmission or delivery of the slurry 138 from the one or more first tanks 104 to the one or more second tanks 143 of the system 101. It is withing the scope of this disclosure and as a non-limiting example that the one or more second pumps (not shown) may be a slurry pump or any other type of pump that is capable of transmitting or delivering an amount of solids.

Once the slurry 138 is within the one or more second tanks 134, it is allowed to remain, rest and/or settle out within the one or more second tanks 134 for a pre-determined amount of time. While within the one or more second tanks 134, the various components of the slurry 138 are allowed to settle out based on their relative densities. As the STC has a lower density than the other components within the slurry 138, over time while the higher density components settle out and concentrate at or near a bottom of the one or more second tanks 134 the STC is allowed to rise above the other components.

The STC may then be recovered form the one or more second tanks 134. The STC recovered may then be recycled and used again in future repetitions of the process 100 described and illustrated herein. It is within the scope of this disclosure and as a non-limiting example that the STC within the slurry 138 contained within the one or more second tanks 134 may be recovered manually, by one or more decanting processes and/or any other process whereby an amount of the STC is able to be separated and retrieved from the slurry 138.

As a non-limiting example, the STC recovered may be recycled or upcycled for use or re-use within the production of chlorosilane materials or products. As a result, the process 100 and the system 101 is more cost effective and environmentally friendly.

According to the embodiment where the STC is removed and/or recovered from the one or more second tanks 134 by using one or more decanting processes, the STC is decanted out of the one or more second tanks 134 by allowing at least a portion of a top layer (not shown) of the settled slurry 138 having the lower density STC therein to be transmitted out of the one or more second tanks 134 without disturbing the higher density portion(s) of the slurry 138. It is within the scope of this disclosure and as a non-limiting example that the one or more second tanks 134 may include one or more third pipes 140 that are in fluid communication with at least a portion of the interior 136 of the one or more second tanks 134. The one or more third pipes 140 may be operably configured to transfer at least a portion of the STC within the one or more second tanks 134 to one or more third tanks 144. Once within the one or more third tanks 144, the STC may be stored and/or further processed as needed for re-use within the process 100 or upcycled as described and illustrated herein.

As illustrated in FIG. 1 of the disclosure and as a non-limiting example, the one or more third pipes 140 may be located at varying heights from the bottom of the one or more second tanks 134. This is done so that only the desired portion of the slurry 138 is drained and transferred to the one or more third tanks 144 without disturbing the higher density portions of the slurry 138 closer to the bottom of the one or more second tanks 134.

It is within the scope of this disclosure and as a non-limiting example that a first end portion 142 of the one or more third pipes 140 may include one or more valves and/or nozzles (not shown). The one or more nozzles and/or valves (not shown) may be operably configured to be opened and closed (turned on or off) as needed to allow or prevent the flow of at least a portion of the STC and/or at least a portion of the slurry 138 from the interior 136 of the one or more second tanks 134 to the one or more third tanks 144. By selectively opening and closing the one or more third pipes 140 and locating the one or more third pipes 140 at different heights from the bottom of the one or more second tanks 134, only the portion of the slurry 138 with the STC may be transferred from the one or more second tanks 134 to the one or more third tanks 144. This allows for a quick, easy and efficient removal of the STC from the one or more second tanks 134 without disturbing the higher density portions of the slurry 138 at the bottom.

As a non-limiting example, at least a portion of the one or more third tanks 144 may be in fluid communication with at least a portion of a second end portion 146 of the one or more third pipes 140 opposite the first end portion 142.

According to an embodiment of the disclosure and as a non-limiting example, the system 101 may include the use of one or more first filters 150 that are in fluid communication with at least a portion of the one or more third pipes 140. As best seen in FIG. 1 and as a non-limiting example, the one or more first filters 150 may be in fluid communication with at least a portion of the second end portion 146 of the one or more third pipes 140. The one or more first filters 150 may be of a size and shape needed to allow for the delivery of STC from the one or more second tanks 134 to the one or more third tanks 144 while preventing or inhibiting unwanted portions of the slurry 138, a settled slurry 139 and/or the one or more solids 102 from entering into the one or more third tanks 144. This aids in ensuring that the STC contained within the one or more third tanks 144 is substantially pure and requires little to no additional processing or refining before being reused, recycled and/or upcycled.

The system 101 may also include the use of one or more sixth pipes 151. The one or more sixth pipes 151 may fluidly connect one or more first filters 150 to the one or more third tanks 144 and have a size and shape needed to allow for the transmission or delivery of the STC collected or recovered to the one or more third tanks 144 of the system 101. As illustrated in FIG. 1 of the disclosure and as a non-limiting example, at least a portion of a first end portion 153 of the one or more sixth pipes 151 may be in fluid communication with at least a portion of the one or more first filters 150. Additionally, as illustrated in FIG. 1 and as a non-limiting example, at least a portion of a second end portion 155 of the one or more sixth pipes 151 opposite the first end portion 153 may be in fluid communication with at least a portion of the one or more third tanks 144.

It is within the scope of this disclosure and as a non-limiting example that the one or more second tanks 134 may be operably configured so as to allow the higher density portion of the slurry 138 and the one or more solids 102 to be transferred out of the one or more second tanks 134 without any low points and/or dead legs thereby ensuring that the one or more solids 102 are flowable or able to be transmitted or delivered out of the one or more second tanks 134 and aiding in limiting or preventing the building up of the one or more solids 102 within the slurry 138 on an inner surface 135 of the one or more second tanks 134.

As a non-limiting example, the one or more second tanks 134 may include the use of one or more additional nozzles 170. According to an embodiment of the disclosure and as a non-limiting example, the one or more additional nozzles 170 may be the same or substantially the same and may function in the same or substantially the same manner as the one or more nozzles 110 described and illustrated herein. The one or more additional nozzles 170 may therefore be operably configured to deliver an amount of the media 112 into the interior 136 of the one or more second tanks 134 and into direct contact with at least a portion of the one or more solids 102, the slurry 138 and/or the settled slurry 139 contained within the one or more second tanks 134. As illustrated in FIG. 1 of the disclosure and as a non-limiting example, it is within the scope of this disclosure and as a non-limiting example that the one or more additional nozzles 170 may be connected to or integrally formed as part of the one or more second tanks 134 utilized within the process 100 and the system 101. Additionally, it is within the scope of this disclosure and as a nonlimiting example that the one or more additional nozzles 170 may be operably configured to deliver an amount of the media 112 in substantially one direction and/or in multiple directions. Furthermore, it is within the scope of this disclosure and as a non-limiting example that the one or more additional nozzles 170 may be one or more high pressure nozzles that aid in breaking down and/or dislodging at least a portion of the one or more solids 102, the slurry 138 and/or the settled slurry 139 from at least a portion of the inner surface 135 of the one or more second tanks 134. As an alternative and as a non-limiting example, the one or more additional nozzles 170 may be one or more low pressure nozzles. Still further, it is within the scope of this disclosure and as a non-limiting example that the one or more additional nozzles 170 may be operably configured to adjust the pressure, force and/or velocity of the media 112 exiting the one or more additional nozzles 170 as needed so as to aid in breaking down and/or dislodging at least a portion of the one or more solids 102, the slurry 138 and/or the settled slurry 139 from at least a portion of the inner surface 135 of the one or more second tanks 134. This aids in allowing for the process 100 and the one or more additional nozzles 170 utilized therein to be customized as needed to ensure that the one or more solids 102, the slurry 138 and/or the settled slurry 139 are broken down and/or dislodged from the inner surface 135 of the one or more second tanks 134. It is within the scope of this disclosure and as a non-limiting example that the one or more additional nozzles 170 may include one type of nozzle or a combination of different types of nozzles as may be need to aid in breaking down and/or dislodging at least a portion of the one or more solids 102, the slurry 138 and/or the settled slurry 139 are broken down and/or dislodged from the inner surface 135 of the one or more second tanks 134.

In accordance with an embodiment of the disclosure and as a non-limiting example, at least a portion of the one or more additional nozzles 170 may be in fluid communication with at least a portion of the one or more media tanks 122 and/or the one or more first pumps 124 by one or more seventh pipes 172. As illustrated in FIG. 1 of the disclosure and as a non-limiting example, at least a portion of the one or more media tanks 122 and/or at least a portion of the one or more first pumps 124 may be in fluid communication with at least a portion of a first end portion 174 of the one or more seventh pipes 172. Additionally, as illustrated in FIG. 1 of the disclosure and as a non-limiting example, at least a portion of the one or more additional nozzles 170 may be in fluid communication with at least a portion of a second end portion 176 of the one or more seventh pipes 172 of the system 101.

As a non-limiting example, the system 101 may also include one or more third valves 178. The one or more third valves 178 may be operably configured to block or prevent the flow of the media 112 from the one or more media tanks to the one or more second tanks 134 or to allow the flow of the media 112 into the interior 136 of the one or more second tanks 134 through the one or more additional nozzles 170. As illustrated in FIG. 1 of the disclosure and as a non-limiting example, the one or more third valves 178 may be in fluid communication at least a portion of an intermediate portion 180 of the one or more seventh pipes 172 located between the first and second end portions 174 and 176 of the one or more seventh pipes 172 of the system 101.

Once the higher density portion of the slurry 138 and the one or more solids 102 have settled toward the bottom of the one or more second tanks 134 (hereinafter the “settled slurry”), settled slurry 139 may be transferred from the one or more second tanks 134 and into one or more fourth pipes 152. As a result, it is to be understood that the settled slurry 139 includes an amount of the one or more solids 102 therein. An end of the one or more fourth pipes 152 opposite the one or more second tanks 134 may be in fluid communication with at least a portion of one or more second filters 154. It is within the scope of this disclosure and as a non-limiting example that the one or more second filters 154 may be one or more interstitial filters and/or any other type of filter or separator that is capable of separating the one or more solids 102 and/or the STC from the settled slurry 139.

In accordance an embodiment of the disclosure and as a non-limiting example, the one or more second filters 154 may be operably configured to allow for the transmission of an amount of the one or more solids 102 within the settled slurry 139 to one or more collection containers 156. Additionally, the one or more second filters 154 may be operably configured to further condense or concentrate the settled slurry 139 thereby forming a concentrated slurry (not shown) by introducing a pre-determined amount of one or more gases into the settled slurry 139 to aid in further condensing or concentrating the settled slurry 139 and moving the settled slurry 139 through the one or more second filters 154. It is within the scope of this disclosure and as a non-limiting example that the one or more gases may be an inert gas such as but not limited to nitrogen. An inert gas is preferred as it aids in inhibiting unwanted chemical reactions with the one or more solids 102 further adding to the increased safety of the process 100.

The concentrated slurry (not shown) may also be formed by other methods or processes which may further condense or concentrate the settled slurry 139. As a non-limiting example, such additional methods or processes may include vacuum concentrating. When using vacuum concentrating, a vacuum may be applied to the settled slurry 139 within the one or more second filters 154 further condensing or concentrating the settled slurry 139 and moving the settled slurry 139 through the one or more second filters 154

According to an embodiment of the disclosure and as a non-limiting example, the one or more second filters 154 may include one or more third filters (not shown) therein. The one or more third filters (not shown) may be operably configured to catch an amount of STC for collection and re-use.

It is within the scope of this disclosure and as a non-limiting example that the one or more third filters (not shown) may not form a portion of the one or more second filters 154 but may be separate. As a result, it is within the scope of this disclosure and as a non-limiting example that the one or more third filters (not shown) may be located between the one or more second tanks 134 and the one or more second filters 154 and in fluid communication with the one or more fourth pipes 152. Additionally, it is within the scope of this disclosure and as a non-limiting example that the one or more third filters (not shown) may be located between the one or more second filters 154 and the one or more collection containers 156 and in fluid communication with at least a portion of one or more fifth pipes 158 fluidly connecting at least a portion of the one or more second filters 154 to at least a portion of the one or more collection containers 156.

The STC collected by the one or more third filters (not shown) may be in fluid communication with at least a portion of an intermediate portion 148 of the one or more third pipes 140. As illustrated in FIG. 1 and as a non-limiting example, the one or more third filters (not shown) may be in fluid connection with at least a portion of the one or more third pipes 140 at a location between the one or more second tanks 134 and the one or more first filters 150. As a result, the STC collected by the one or more third filters (not shown) may be transmitted or delivered to the one or more third tanks 144 for collection and/or re-use.

As best seen in FIG. 1 of the disclosure and as a non-limiting example, the system 101 may include the use of one or more first valves 160 and/or one or more second valves 162. As a non-limiting example, the one or more first valves 160 and/or the one or more second valves 162 may be operably configured to limit, prevent or allow for the flow of the one or more solids 102, the settled slurry 139 and/or the concentrated slurry (not shown) through the one or more second filters 154. Additionally, it is within the scope of this disclosure and as a non-limiting example that the one or more first valves 160 and/or the one or more second valves 162 may be used for safety purposes and/or for dosing of the one or more solids 102, settled slurry 139 and/or the concentrated slurry (not shown). The one or more first valves 160 may be interposed between the one or more second filters 154 and the one or more second tanks 134 and in fluid communication with the one or more fourth pipes 152 and the one or more second filters 154. The one or more second valves 162 may be interposed between the one or more second filters 154 and the one or more collection containers 156 and in fluid communication with the one or more fifth pipes 158 and the one or more second filters 154. It is within the scope of this disclosure and as a non-limiting example that the one or more first and second valves 160 and 162 may be one or more gate valves and/or one or more knife gate valves or any other type of valve that is operable or functional with solids and/or slurries (or mixtures) having an amount of solids therein.

Additionally, by selectively opening and closing the one or more second valves 160, it allows for quicker and easier cleaning, replacement and/or maintenance of the one or more second filters 154 and/or the system 101.

The concentrated slurry (not shown) containing the one or more solids 102 exiting the one or more second filters 154 may be transmitted or delivered from the one or more second filters 154 to the one or more collection containers 156 for storage and disposal. It is within the scope of this disclosure and as a non-limiting example that the concentrated slurry (not shown) may be hazardous waste.

According to an embodiment of the disclosure and as an non-limiting example, the one or more second filters 154 may be in fluid communication with at least a portion of the one or more third tanks 144. This will allow for at least a portion of the STC collected by the one or more second filters 154 to be transferred to and stored within the one or more third tanks 144. As a non-limiting example, the one or more second filters 154 may be in fluid communication with at least a portion of the one or more third pipes 140 by use of one or more eight pipes 182.

In accordance with an embodiment of the disclosure and as a non-limiting example, the process 100 and system 101 may include the use of an amount of polydimethylsiloxane (or PDMS). The PDMS (not shown) may be used as a passivation agent by coats, enveloping and/or encapsulating at least a portion of the one or more solids 102 rendering then non-reactive to air, water and/or moisture. This aids in improving the overall safety of the process 100 and the system 101. It is within the scope of this disclosure and as a non-limiting example that a mixture of approximately 50:50 to approximately 30:70 based on the weight of the one or more solids 102 to the PDMS (not shown) may be effective in rendering the one or more solids 102 non-reactive to air and/or moisture. In particular, a mixture of 40:60 based on the weight of the one or more solids 102 to the PDMS (not shown) may be effective in rendering the one or more solids 102 non-reactive to air and/or moisture.

As illustrated in FIG. 1 and as a non-limiting example, the PDMS (not shown) may be stored within one or more fourth tanks 164. The one or more forth tanks 164 may be in fluid communication with at least a portion of one or more sixth pipes 166. An end portion of the one or more sixth pipes 166 may be in fluid communication with at least a portion of the one or more fifth pipes 158 at a location between the one or more second filters 154 and the one or more collection containers 156. This aids in ensuring that the one or more solids 102 going into the one or more collection containers 156 is non-reactive thereby aiding in improving the overall safety of the process 100 and the system 101.

It is within the scope of this disclosure and as a non-limiting example that the process 100 and the system 101 may be a closed system thereby aiding in further preventing the one or more solids 102 from coming into contact with an amount of water and/or air. This aids in improving the overall safety of the process 100 and the system 101.

According to an embodiment of the disclosure and as a non-limiting example, at least a portion of the system 101 may be integrated within at least a portion of a polysilicon production process (or system) or may be a completely separate system. As a non-limiting example, the one or more media tanks 122, the one or more first pumps 124, the one or more first tanks 104 and/or the one or more third tanks 144 of the system 101 may form at least a portion of a polysilicon production process (or system). It is therefore within the scope of this disclosure and as a non-limiting example that the remaining portions of the system 101 may be independent of the a polysilicon production process (or system) and may only be used within the process 100 and/or system 101 described and illustrated herein.

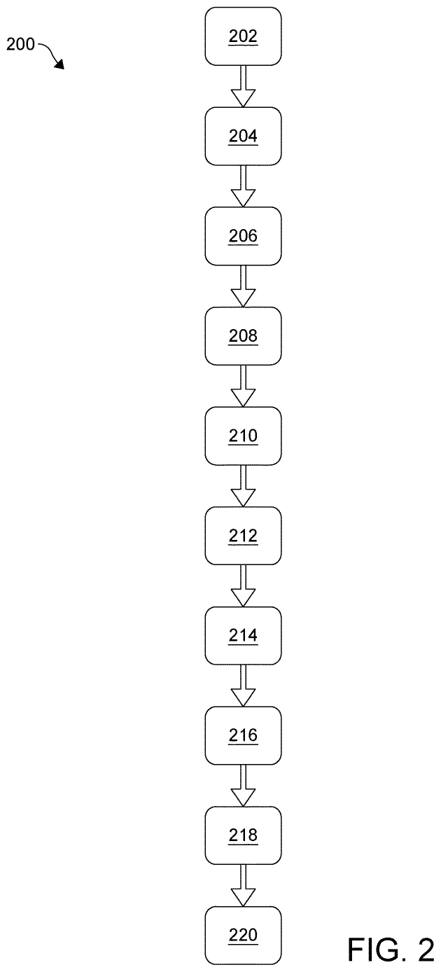

As illustrated in FIG. 2 of the disclosure and as a non-limiting example, it illustrates a process 200 for cleaning, removing, dislodging and/or disposing of an amount of the one or more solids 102 from the one or more first tanks 104. The process 200 includes contacting 202 at least a portion of the one or more solids 102 within the one or more first tanks 104 and/or the one or more second tanks 134 with a pre-determined amount of the media 112. Once in contact 202 with the one or more solids 102, the slurry 138 is allowed to form 204 within the one or more first tanks 104 of the system 101. After the slurry 138 has been formed 204, at least a portion of the slurry 138 may be transmitted or delivered 206 to the one or more second tanks 134. Within the one or more second tanks 134, the slurry 138 is allowed to settle and/or form 208 a settled slurry 139. The lower density STC is then removed 210 from the one or more second tanks 134 and transmitted or delivered 212 to the one or more third tanks 144 for re-use 216. After the settled slurry 139 has been formed 208, at least a portion of the one or more solids 102 within the settled slurry 139 may be transmitted or delivered 218 from the one or more second tanks 134 to the one or more collection tanks 156. Before the settled slurry 139 is transmitted or delivered 218 from the one or more second tanks 134 to the one or more collection tanks 156, a pre-determined amount of the PDMS (not shown) may be introduced 220 in order to passivate and prevent the one or more solids 102 from reacting when in contact with water and/or air with moisture.

It is within the scope of this disclosure and as a non-limiting example that the process 200 may be a closed system thereby aiding in further preventing the one or more solids 102 from coming into contact with an amount of water and/or air. This aids in improving the overall safety of the process 200.

It is to be understood that the various embodiments described in this specification and as illustrated in the attached drawings are simply exemplary embodiments illustrating the inventive concepts as defined in the claims. As a result, it is to be understood that the various embodiments described and illustrated may be combined to from the inventive concepts defined in the appended claims.

In accordance with the provisions of the patent statutes, the present invention has been described to represent what is considered to represent the preferred embodiments. However, it should be noted that this invention can be practiced in other ways than those specifically illustrated and described without departing from the spirit or scope of this invention.

What is claimed is:

1. A system for cleaning one or more tanks, comprising:
one or more media tanks in fluid communication with at least a portion of one or more first tanks;
wherein the one or more media tanks comprise an amount of a media therein;
wherein the media comprises an amount of silicon tetrachloride (STC);
wherein at least a portion of the media is brought into contact with at least a portion of one or more solids within the one or more first tanks to form a slurry;
wherein the slurry is delivered from the one or more first tanks to one or more second tanks where a settled slurry is formed that includes an amount of the one or more solids therein;
wherein at least a portion of the STC is removed from the one or more second tanks and collected within one or more third tanks; and
wherein at least a portion of the one or more solids are collected from the settled slurry formed within the one or more second tanks.

2. The system of claim 1, wherein the one or more solids comprise one or more metal chlorides, aluminum chloride (AlCl3), silicon (grounds and/or fines), chlorosilanes, and/or high boiling chlorosilanes.

3. The system of claim 1, wherein the one or more first tanks comprise one or more nozzles that are operably configured to deliver at least a portion of the media into the one or more first tanks; and/or
wherein the one or more first tanks comprise one or more nozzles that are operably configured to bring at least a portion of the media into contact with at least a portion of the one or more solids within the one or more first tanks.

4. The system of claim 1, wherein the one or more second tanks comprise one or more additional nozzles that are operably configured to bring at least a portion of the media into contact with at least a portion of the one or more solids, the slurry and/or the settled slurry within the one or more second tanks.

5. The system of claim 1, further comprising one or more first pumps, wherein the one or more first pumps are operably configured to aid in delivering an amount of the media from within the one or more media tanks to the one or more first tanks and/or the one or more second tanks.

6. The system of claim 1, further comprising one or more third valves;
wherein the one or more third valves are operably configured to selectively deliver an amount of the media to the one or more second tanks.

7. The system of claim 1, wherein at least a portion of the media is recycled and/or upcycled from the production of polysilicon materials.

8. The system of claim 1, wherein the STC within the media dissolves or extracts at least a portion of chlorosilanes and/or high boiling chlorosilane residues found within the one or more solids; and/or
wherein the STC within the media forms a suspension with at least a portion of one or more metal chlorides, aluminum chloride (AlCl3) and/or silicon found within the one or more solids which aids in the removal of the one or more solids form the system.

9. The system of claim 1, wherein the one or more solids are not exposed to an amount of air, moisture and/or water.

10. The system of claim 1, wherein the one or more first tanks comprise one or more nozzles are integrally formed as part of the one or more first tanks; and/or
wherein the one or more nozzles are connected to an assembly that is operably configured to move the one or more nozzles in such a manner that the media is brought into contact with the one or more solids on an inner surface of the one or more first tanks.

11. The system of claim 1, further comprising one or more first filters; and
wherein the one or more first filters are operably configured allow for the delivery of the STC from the one or more second tanks to the one or more third tanks while preventing or inhibiting unwanted portions of the slurry, a settled slurry and/or the one or more solids from entering into the one or more third tanks.

12. The system of claim 1, further comprising one or more second filters;
wherein the one or more second filters are operably configured to separate the one or more solids and the STC from the settled slurry; and
wherein the one or more second filters are operably configured to allow for the transfer of the one or more solids to one or more collection containers.

13. The system of claim 1, further comprising polydimethylsiloxane; and
wherein the polydimethylsiloxane encapsulates at least a portion of the one or more solids preventing the one or more solids from being reactive to air, water and/or moisture.

14. The system of claim 13, wherein the polydimethylsiloxane is present in an amount of approximately 50:50 to approximately 30:70 based on the weight of the one or more solids to the polydimethylsiloxane.

15. A process for cleaning one or more tanks, comprising:
providing a media, wherein the media comprises silicon tetrachloride (STC);
contacting at least a portion of the media within at least a portion of one or more solids within one or more first tanks;
forming a slurry within the one or more first tanks, wherein the slurry comprises the media and the one or more solids;
delivering the slurry to one or more second tanks;
removing and collecting an amount of the STC from the one or more second tanks;
allowing a settled slurry to form within the one or more second tanks;
collecting an amount of the one or more solids from the settled slurry formed; and
re-using at least a portion of the STC collected.

16. The process of claim 15, further comprising the step of providing an amount of polydimethylsiloxane; and
encapsulating at least a portion of the one or more solids with at least a portion of the polydimethylsiloxane so as to render the one or more solids non-reactive to air, water and/or moisture.

17. The process of claim 16, wherein the polydimethylsiloxane is present in an amount of approximately 50:50 to approximately 30:70 based on the weight of the one or more solids to the polydimethylsiloxane.

18. The process of claim 15, further comprising delivering the one or more solids collected to one or more collection containers.

19. The process of claim 15, further comprising the steps of dissolving or extracting at least a portion of chlorosilanes and/or high boiling chlorosilane residues found within the one or more solids with the STC; and/or
forming a suspension, wherein the suspension includes an amount of the STC from within the media and one or more metal chlorides, aluminum chloride (AlCl3) and/or silicon found within the one or more solids for collection and/or removal of the one or more solids.

20. The process of claim 15, further comprising filtering and separating an amount of the STC and the one or more solids from the settled slurry formed within the one or more second tanks with one or more second filters;
transferring the STC separated by the one or more second filters to one or more third tanks and/or for re-use; and
transferring the one or more solids separated by the one or more second filters to one or more collection containers

21. The process of claim 15, further comprising the steps of delivering an amount of the media to the one or more second tanks; and
contacting at least a portion of the media with at least a portion of the one or more solids, the slurry and/or the settled slurry within the one or more second tanks.
